(19) United States
(12) Patent Application Publication
(10) Pub. No.: US 2024/0149917 A1
(43) Pub. Date: May 9, 2024

(54) TRANSPORTATION SYSTEM FOR AUTONOMOUS VEHICLES

(71) Applicant: GLYDWAYS INC., South San Francisco, CA (US)

(72) Inventors: Keith Flynn, Pleasanton, CA (US); Nicholas Gibson, Tokyo (JP); Mark E. Seeger, South San Francisco, CA (US)

(21) Appl. No.: 18/387,786

(22) Filed: Nov. 7, 2023

Related U.S. Application Data
(60) Provisional application No. 63/423,378, filed on Nov. 7, 2022.
(60) Provisional application No. 63/423,380, filed on Nov. 7, 2022.

(51) Int. Cl. B60W 60/00; B60W 30/16; B60W 40/076; G08G 1/00

(52) U.S. Cl. CPC B60W 60/00253; B60W 30/16; B60W 40/076; G08G 1/202; B60W 2520/06; B60W 2552/15; B60W 2554/80

(57) ABSTRACT

A transportation system for autonomous vehicles may include a control system configured to determine respective vehicle trajectories for respective autonomous vehicles and to provide the respective vehicle trajectories to the respective autonomous vehicles. The transportation system may also include a pair of roadways extending alongside one another and physically divided from one another, a first roadway of the pair of roadways configured for vehicle travel in a first direction, and a second roadway of the pair of roadways configured for vehicle travel in a second direction opposite the first direction, a boarding zone that is vertically separated from the pair of roadways and includes a set of boarding slots configured to receive autonomous vehicles, and a mixing zone adjacent the set of boarding slots and configured to allow vehicle access to the set of boarding slots for vehicles from the first roadway and the second roadway.

### CROSS-REFERENCE TO RELATED APPLICATION(S)

This application is a nonprovisional patent application of and claims the benefit of U.S. Provisional Patent Application No. 63/423,378, filed Nov. 7, 2022 and titled “Transportation System,” and this application is a nonprovisional patent application of and claims the benefit of U.S. Provisional Patent Application No. 63/423,380, filed Nov. 7, 2022 and titled “Transportation System,” the disclosures of which are hereby incorporated herein by reference in their entireties.

### FIELD

The described embodiments relate generally to roads for vehicles, and, more particularly, to separated grade (elevated) roadways for autonomous vehicles.

### BACKGROUND

Vehicles, such as cars, trucks, vans, busses, trams, and the like, are ubiquitous in modern society. Cars, trucks, and vans are frequently used for personal transportation to transport relatively small numbers of passengers, while busses, trams, and other large vehicles are frequently used for public transportation. Vehicles may also be used for package transport or other purposes. Such vehicles may be driven on roads, which may include surface roads, bridges, highways, overpasses, or other types of vehicle rights-of-way. Driverless or autonomous vehicles may relieve individuals of the need to manually operate the vehicles for their transportation needs.

### SUMMARY

A transportation system for autonomous vehicles may include a control system configured to determine respective vehicle trajectories for respective autonomous vehicles and to provide the respective vehicle trajectories to the respective autonomous vehicles. The transportation system may also include a pair of roadways extending alongside one another and physically divided from one another, a first roadway of the pair of roadways configured for vehicle travel in a first direction, and a second roadway of the pair of roadways configured for vehicle travel in a second direction opposite the first direction, a boarding zone that is vertically separated from the pair of roadways and includes a set of boarding slots configured to receive autonomous vehicles, and a mixing zone adjacent the set of boarding slots and configured to allow vehicle access to the set of boarding slots for vehicles from the first roadway and the second roadway. The mixing zone may include a first mixing lane connected to the first roadway and a second mixing lane connected to the second roadway and positioned between the first mixing lane and the set of boarding slots. The control system may be configured to provide a vehicle arrival trajectory to a vehicle, the vehicle arrival trajectory configured to cause the vehicle to enter the first mixing lane from the first roadway and cross the second mixing lane to arrive at a boarding slot. The control system may also be configured to provide a vehicle departure trajectory to the vehicle in the boarding slot, the vehicle departure trajectory configured to cause the vehicle to cross the second mixing lane to initiate travel along the first roadway.

In a first portion of the vehicle departure trajectory, the vehicle may travel in a direction of a first end of the vehicle, and in a second portion of the vehicle departure trajectory, the vehicle may travel in a direction of a second end of the vehicle. The pair of roadways may be vertically elevated relative to the boarding zone. The boarding zone may be at grade level, and the pair of roadways may be below grade level. The vehicle departure trajectory may define a travel path that merges the vehicle into the first roadway between a first moving vehicle having a first known trajectory and a second vehicle having a second known trajectory. The vehicle may be a first vehicle, and the control system may be configured to generate the vehicle departure trajectory based at least in part on a preexisting vehicle trajectory of a second vehicle traveling along the first roadway, the vehicle departure trajectory configured to maintain a separation distance between the first vehicle and the second vehicle along the first roadway. The first mixing lane and the second mixing lane may be positioned between a bypass segment of the first roadway and a bypass segment of the second roadway.

A method of operating vehicles in a transportation system including a plurality of autonomous vehicles configured to autonomously navigate along a roadway system may include, at a control system configured to determine respective vehicle trajectories for respective autonomous vehicles and to provide the respective vehicle trajectories to the respective autonomous vehicles, providing a first vehicle trajectory to a first vehicle, the first vehicle trajectory including instructions to autonomously travel along a first roadway to a first buffer zone connected to a first mixing lane of a boarding zone, and providing a second vehicle trajectory to a second vehicle, the second vehicle trajectory including instructions to autonomously travel along a second roadway to a second buffer zone connected to a second mixing lane of the boarding zone. The method may further include initiating a first arrival operation including causing the first vehicle to pause in the first buffer zone and causing the second vehicle to traverse a portion of the second mixing lane in a first travel direction and enter a first boarding slot, and after the first arrival operation, initiating a second arrival operation including causing the first vehicle to traverse a portion of the first mixing lane and traverse the portion of the second mixing lane in a second travel direction opposite the first travel direction and enter a second boarding slot.

The respective vehicle trajectories for the respective autonomous vehicles may include a minimum separation distance between the respective autonomous vehicles. The method may further include, after the second arrival operation, initiating a coordinated vehicle departure operation including providing a third vehicle trajectory to the first vehicle, the third vehicle trajectory configured to cause the first vehicle to exit the second boarding slot and autonomously travel along the second roadway, and providing a fourth vehicle trajectory to the second vehicle, the fourth vehicle trajectory configured to cause the second vehicle to exit the first boarding slot at a same time that the first vehicle exits the second boarding slot and autonomously travel along the second roadway.

The boarding zone may be vertically separated from the first roadway and the second roadway. The boarding zone may be between a first bypass segment of the first roadway and a second bypass segment of the second roadway. The first roadway may be a first elevated roadway, the second roadway may be a second elevated roadway, a first ramp may connect the first elevated roadway to the first mixing lane, and a second ramp may connect the second elevated roadway to the second mixing lane.

A roadway system for autonomous vehicles may include a grade-level boarding zone including a first grade-level road segment configured to receive traffic traveling in a first direction, a second grade-level road segment configured to receive traffic traveling in a second direction opposite the first direction, and a set of boarding slots along a side of the first grade-level road segment and accessible via the first grade-level road segment and the second grade-level road segment. The roadway system may further include a first roadway configured for traffic traveling in the first direction and including a first elevated road segment, a second elevated road segment, a first offramp joining the first elevated road segment of the grade-level boarding zone to the first grade-level road segment, a first onramp joining the first grade-level road segment of the grade-level boarding zone to the second elevated road segment, and a first elevated bypass segment joining the first elevated road segment to the second elevated road segment. The roadway system may further include a second roadway configured for traffic traveling in the second direction and including a third elevated road segment, a fourth elevated road segment, a second offramp joining the third elevated road segment to the second grade-level road segment of the grade-level boarding zone, a second onramp joining the second grade-level road segment of the grade-level boarding zone to the fourth elevated road segment, and a second elevated bypass segment joining the third elevated road segment to the fourth elevated road segment.

The first and second onramps and the first and second offramps may be between the first elevated bypass segment and the second elevated bypass segment. The boarding zone may lack intersections with roads accessible by conventional vehicle traffic. The first roadway may be physically isolated from the second roadway. The first onramp may be alongside the second offramp, and the second onramp may be alongside the second onramp. The roadway system may further include a control system configured to determine respective vehicle trajectories for respective autonomous vehicles and to provide the respective vehicle trajectories to the respective autonomous vehicles, the respective vehicle trajectories for the respective autonomous vehicles configured to maintain a minimum separation distance between the respective autonomous vehicles. The control system may be further configured to provide a vehicle arrival trajectory to a vehicle, the vehicle arrival trajectory configured to cause the vehicle to enter the first grade-level road segment from the first roadway and cross the second grade-level road segment to arrive at a boarding slot, and provide a vehicle departure trajectory to the vehicle in the boarding slot, the vehicle departure trajectory configured to cause the vehicle to cross the second grade-level road segment to initiate travel along the first roadway.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic representation of an example transportation system.

FIG. 2 depicts a map of an example roadway system of a transportation system.

FIG. 3A depicts a portion of an example roadway system with a boarding zone and vertically separated bypass segments.

FIGS. 3B-3C depict top views of an example boarding zone and vertically separated bypass segments.

FIG. 3D depicts a ramp section of an example boarding zone with vertically separated roadway segments.

FIGS. 4A-4B depict example boarding zones with vertically separated bypass segments.

FIGS. 5A-5D depict example vehicle arrival and departure maneuvers as defined by arrival and departure trajectories.

FIGS. 6A-6C depict an example vehicle.

FIGS. 7A-7B depict the vehicle of FIGS. 6A-6C with its doors open.

FIG. 8 depicts a partial exploded view of an example vehicle.

FIG. 9 illustrates an electrical block diagram of an electronic device that may perform the operations described herein.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to a transportation system in which numerous vehicles may be autonomously operated to transport passengers and/or freight along roadways within a roadway system or network. For example, a transportation system or service may provide a fleet of vehicles that operate in a roadway system to pick up and drop off passengers at either pre-set locations or stops, or at dynamically selected locations (e.g., selected by a person via a smartphone).

In a transportation system as described herein, it may be advantageous to provide systems and techniques that facilitate efficient and safe boarding operations without disrupting traffic flow throughout the system. Moreover, in environments where a transportation system for small autonomous vehicles is integrated with existing infrastructure, landscapes, and populated areas, it may be necessary to provide safe separation between travel lanes of the transportation system and other structures (e.g., roads, thoroughfares, pedestrian paths, sidewalks etc.) and avoid disrupting or interfering with vehicle or human traffic in those areas. One solution includes vertically separating roadways from a grade level. For example, roadways, or portions thereof, may be positioned above or below grade. However, it may be preferable in some locations to allow passengers to board and exit vehicles at a grade-level boarding zone. Due to the crowded nature of the environments in which the transportation system may be deployed, compact and efficient positioning of the various roadways, roadway segments, boarding zones, and other infrastructure or other elements may contribute to the overall efficiency of the system.

For example, as described herein, a transportation system may include a pair of vertically separated roadways (e.g., elevated roadways) that run generally alongside one another. The vertically separated roadways may be isolated from one another (e.g., via fences, barriers, separate road surfaces, etc.), and may each be configured for vehicle travel in a single direction (e.g., opposing direction traffic is separated by a barrier). Where a grade-level boarding zone is required, the roadways diverge around a pair of access lanes that include onramps and offramps such that vehicles on the roadways can easily merge off of the roadway and access the boarding zone. The roadways include bypass segments that wrap around the access lanes and the grade-level boarding zone, such that vehicles that do not need to access the boarding zone can simply continue along their trajectory without being delayed by vehicles that are accessing the boarding zone or otherwise have to wait for boarding operations. This configuration of a grade-level boarding zone positioned between a pair of elevated bypass segments provides a highly space-efficient configuration for the placement of boarding zones, while also allowing a continuous flow of traffic around the boarding zone.

As described herein boarding zones may be configured so that vehicles traveling along either roadway (e.g., in opposite directions) can access the vehicle boarding slots, and vehicles in the boarding slots can access both roadways. Accordingly, boarding zones may include mixing lanes that are not limited to a single vehicle travel direction, and which may be crossed by the vehicles or used by the vehicles for parking or departure maneuvers. In order to ensure that vehicles maintain safe separation distances (e.g., a minimum allowable separation distance) or otherwise do not interfere with one another in the boarding zones during such operations, a system controller may provide instructions or trajectories to the vehicles that coordinate the movement of multiple vehicles at the boarding zones. The vertically separated roadway and boarding zone configuration described herein allows these highly coordinated vehicle maneuvers to be performed in a physically separated region (e.g., the grade-level boarding zone that is outside of the continuous traffic flow), thus reducing the impact of boarding operations on the continuous traffic flow along the main roadways.

In some cases, all boarding zones in a given transportation system or roadway system can be bypassed by roadway segments that allow continuous flow (e.g., bypass lanes). Thus, passengers who do not need to access a particular boarding zone can simply bypass that boarding zone, thereby increasing system efficiency and minimizing travel times.

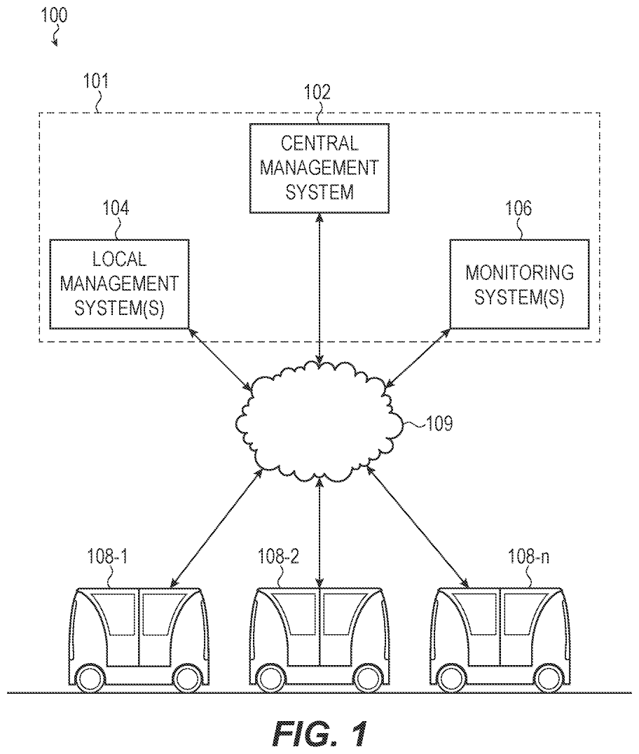

FIG. 1 illustrates an example transportation system 100 that may use the techniques and include the systems and infrastructure described herein. The transportation system 100 includes a control system 101 that can communicate with autonomous vehicles 108 (e.g., vehicles 108-1, . . . , 108-n) of the transportation system (as well as numerous other systems, components, sensors, etc.), to facilitate the operations of the transportation system. The control system 101 may include a central management system 102, one or more local management system(s) 104, and one or more track monitoring system(s) 106 (though the control system 101 may include or be implemented by different systems or combinations of systems). The various systems, components, computers, servers, sensors, etc., of the transportation system 100 may communicate via one or more communication systems 109. While the central management system 102 and the local management system(s) 104 are shown in FIG. 1 as separate elements, these systems may be combined in some example transportation systems. More particularly, functions and/or operations that are described herein as being performed or otherwise associated with the central management system 102 or the local management system(s) 104 may be performed by a single management system (e.g., the functions of the local management system(s) 104 may be performed by the central management system 102). In general, a particular association between a function or operation and a management system relates to an example implementation, and in other example implementations, different functions and/or operations are associated with and/or performed by other management and/or control systems.

The central management system (CMS) 102 may be configured to automatically allocate resources across the network. This may include allocating vehicles to service current trip requests from users, pre-positioning vehicles at stations in anticipation of projected ridership, allocating vehicles to and/or from maintenance and storage facilities in response to vehicle state and current and/or projected system demands. The CMS may maintain a real-time model of full-system status, including the location of every autonomous vehicle in the system, as well as the trajectory for each vehicle. The trajectory for a vehicle may define the position and velocity of a vehicle within the transportation system as a function of time, and thus both provides the CMS information about where each vehicle will be at a given time (e.g., in the future), and also provides individual vehicles with instructions for how to traverse a route within the system. More specifically, the trajectory for a vehicle may define the location and velocity of the vehicle at all times as it executes a trip, and the vehicle may autonomously maintain coincidence with its expected position (to an allowable degree of deviation or error). Stated another way, the vehicle is configured to follow (e.g., maintain coincidence with) its position and velocity target as defined by the vehicle trajectory, such that the vehicle is always at its expected position and speed at the expected time.

As described herein, the vehicle trajectories for each vehicle in the system may be fully deconflicted. As used herein, a fully deconflicted trajectory may refer to a vehicle trajectory along at least a portion of the roadways in the transportation system that does not conflict with other autonomous vehicles in the system or known obstacles in the system. Thus, if each vehicle in the system only moves within the system according to a fully deconflicted trajectory (e.g., one that avoids all other vehicle's trajectories and that accounts for where the vehicles are along their route at any given time), then optimal and reduced-risk operation can be achieved.

The CMS 102 may also facilitate both automated and human supervision of the entire transportation system 100. For example, the CMS 102 may receive information from other systems or components of the transportation system 100 (e.g., vehicles, sensors, the track monitoring system 106, the local management system 104, etc.), and make adjustments to the system as necessary.

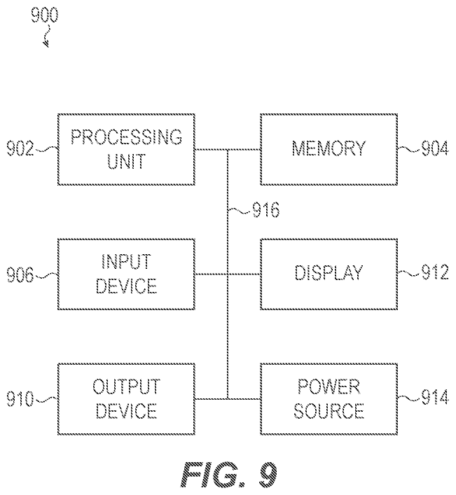

In some cases, the CMS 102 receives trip requests (and optionally other information) from users of the system. Trip requests may include information such as the identity of the requestor, an origin location (e.g., a boarding zone or other location where the user is to be picked up), a destination location (e.g., a boarding zone or other location where the user is to be dropped off), and, optionally, a requested vehicle arrival time (e.g., a time at which the vehicle should arrive at the origin location). Trip requests may be sent to the CMS 102 via smartphones, kiosks (e.g., at boarding zones or other locations), computers, conventional telephones, wearable devices, or any other suitable device and/or communication technique. The CMS 102 may include one or more electronic devices, such as computer systems, such as the electronic device 900 described with respect to FIG. 9.

In some cases, the control system 101 may include one or more local management systems (LMS) 104. The LMS 104 may coordinate and control of movement of vehicles within a localized system context (e.g., boarding zone, maintenance and storage facility, roadway section, etc.). The LMS 104 may coordinate movement within mixing zones or mixing lanes (e.g., at boarding zones) within those contexts. The LMS 104 may provide and require the continuous signal to/from vehicles required to allow movement authority, coordinate motion within mixing zones or mixing lanes, and monitor and enforce safety invariants (e.g., monitoring and enforcing safe vehicle separation). In some cases, the functions of the LMS 104 may be performed by the CMS 102 (or another suitable system or device). In some cases, the LMS 104 may be understood as a service that is instantiated by another system or device, such as the CMS 102. In some cases, multiple LMS 104 may be distributed among the various zones, regions, facilities, or other physical or logical system delineations.

The control system 101 may also include one or more track monitoring systems (TMS) 106. The track monitoring systems 106 may be positioned at various locations within the transportation system, including along roadways, boarding zones, at storage and maintenance facilities, and the like. The TMS 106 may include sensing systems to detect various conditions and events within the system. The sensing systems may include high-resolution (e.g., 0.2-2 mrad), low-latency (<100 ms), long-range (>600 feet) tri-band redundant sensing systems (lidar, radar, camera), and dual-band redundant wireless communication systems. The TMS 106 may provide automated system monitoring including automated vehicle monitoring and automated intrusion detection and may monitor for and provide low-latency response to any violations of system safety invariants. In some cases, track monitoring systems 106 may be deployed at intervals along a roadway, such as every 140-320 feet along the roadway. The particular interval may depend on geographical conditions, roadway properties (e.g., straights vs. turns vs. elevation changes), etc. Track monitoring systems 106 may also be deployed at boarding zones, maintenance and storage facilities, and the like. In some cases, every location in the transportation system that allows for vehicle travel may include one or more TMS 106.

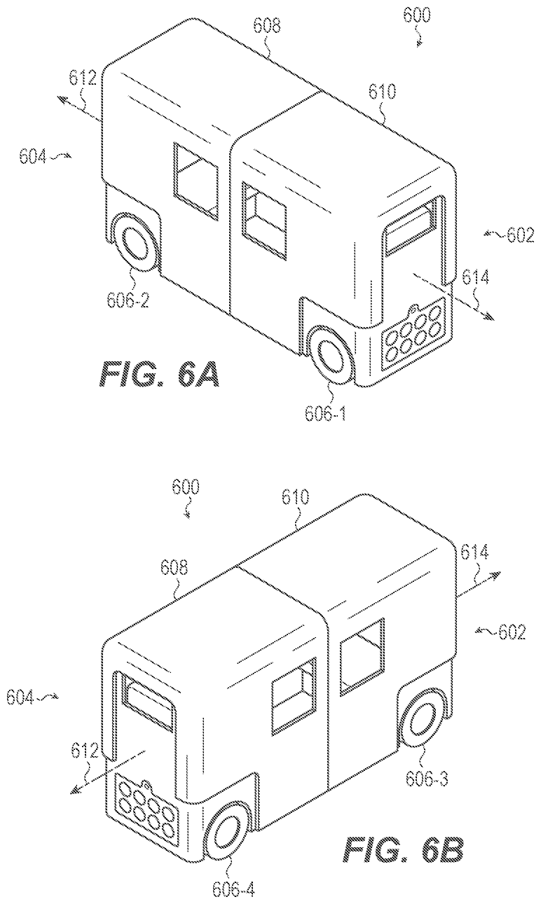

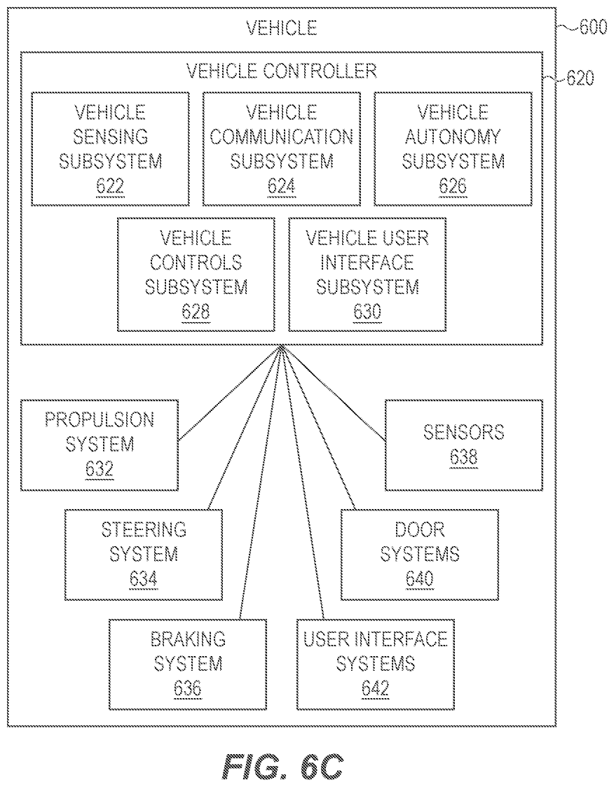

The transportation system 100 also includes vehicles 108. The vehicles 108 may be autonomous or semi-autonomous vehicles specifically designed for use with the transportation system 100. One example type of vehicle 108 is described with respect to FIGS. 6A-8B, though other types of vehicles may be included instead of or in addition to those described herein. The vehicles 108 may be configured to independently and at least semi-autonomously operate according to particular vehicle control schemes established for particular roadway segments and/or other transportation system infrastructure. While certain aspects of vehicle operation may be fully controlled by the vehicle itself, other aspects may be controlled and/or determined by the CMS 102 or the control system 101 more generally. For example, the CMS 102 may provide fully deconflicted vehicle trajectories to the vehicles 108, and the vehicles may perform vehicle operations (e.g., steering, acceleration, braking, etc.) in order to maintain coincidence with the position target defined by the trajectory (while also monitoring for and accounting for safety issues such as obstacles, roadway or environmental conditions, etc.).

As noted, the transportation system 100 may provide various ways for users to request and modify ride requests. For example, kiosks may be provided at boarding zones (or other locations) from which users can schedule, pay for, and optionally modify ride requests. Kiosks may include touchscreen displays (or other types of displays and/or user interface systems) that can provide information to users and accept input from the users. In some cases, the kiosks may provide information about how to use the kiosks to request rides (and/or about other aspects of the transportation system), such as by presenting audio and/or video tutorials, instructions, and the like.

An example ride scheduling operation at a kiosk is described to illustrate example functionality of the kiosk. A user may initiate a kiosk interaction, such as by touching or tapping a touchscreen display. In response, the kiosk may display a map of potential destinations within the transportation system. A list of those destinations with cost and average ride time may also be displayed. In response to a user tapping a destination (and optionally after the user confirms the destination), the CMS 102 may initiate a ride for that user, as described herein.

In some cases, after selecting (and optionally confirming) a destination, a credential item may be associated with the user and/or the trip request. The credential item may be a mobile phone, smart watch, key fob, or any other device or item that can be used by the system to identify the user (e.g., via optical recognition, near field wireless systems, or the like). In some cases, the credential item may be a multi-function card in the user's possession, or a credential card that is provided to the user (e.g., via the kiosk). The credential card may be enabled for wireless communication, such as via near-field communication systems, or the like. The credential item may allow the user to identify themselves to various components within the system (e.g., kiosks, an assigned vehicle), and may be used by the transportation system to initiate certain actions in response to a scan or other identification of the credential card (e.g., to cause vehicle doors to be opened when the user arrives, close the vehicle doors when the user has boarded, etc.).

After a destination is selected, the user may be prompted to provide payment for the ride. Payment may be provided via a payment account that is associated with the user, or directly via the kiosk (e.g., via payment card, cash, digital wallets, wireless payment devices, etc.). After a trip has been requested and the user has paid, the system will associate the trip with the user within the system. The system may also assign a boarding slot to the trip and cause the identifier of the boarding slot to be displayed to the user (e.g., on the kiosk, on a user's device, etc.).

Once the user arrives at the assigned boarding slot, the user may identify themself to a waiting vehicle, such as by scanning a credential item, ticket, or the like. Upon determining that the user has arrived for the trip for which they are associated (and that is associated with that boarding slot and/or vehicle), the vehicle doors may open and the trip may be initiated.

Kiosks may also be used to modify or cancel a ride. For example, the user may scan their credential card, device, ticket, etc., at a kiosk, and make changes directly via the user interface. In some cases, the system may assign a different boarding slot to the modified trip request, and inform the user of the new boarding slot.

Rides may also be requested, modified, and otherwise managed via an application on a device, such as a mobile phone, smart watch, etc. The process may be substantially similar to that provided by the kiosk. The application may also provide access to customer support, tutorials, instructions, and the like. As noted herein, a user's mobile phone or other electronic device may be used as a credential item. Thus, a user can execute an entire ride using their mobile phone to request a ride, pay for the ride, confirm details of the ride, identify themselves to the vehicle and/or other system components, and the like.

Once a user is in a vehicle for their ride, they may initiate a door closing operation. Once initiated, the vehicle may provide an indication that the doors are closing (e.g., an audio and/or visual indication), optionally including a countdown to the door closure. The user may pause the door closure at any time (e.g., via a vehicle or device user interface), or otherwise request that the doors reopen.

Once the doors are closed, the vehicle may initiate the trip, including indicating to the system that it is prepared for departure, and receiving a fully deconflicted trajectory (including departure maneuvers, as described herein). During the ride, a progress bar or other trip progress information (e.g., a moving indication on a map of the roadway system) may be displayed to the user, via the vehicle's user interface and/or on the user's device. During the ride, the user may access customer support via the vehicle or their mobile phone or other device.

The transportation system may allow both personal rides and shared rides, in which the transportation system allows different users who are not part of the same party to share a vehicle to a same destination. Shared rides may have a different pricing schedule, and may help reduce wait times at times of high system demand. In some cases, users must opt-in to shared rides, and can always request a personal ride instead. In some cases, shared ride options are only available at certain times, origin locations, and/or destination locations.

When shared rides are available, an option to select a shared ride may be presented to a user when they select their origin and destination (e.g., at a kiosk or via a device application). In some cases, estimated wait times for personal and shared ride options service are displayed to the user. In response to a user selection of a shared ride, the user is directed to a specific boarding slot where other riders going to the same destination are also directed. This boarding slot may be dedicated to shared rides going to a single destination to simplify the boarding process.

At the dedicated boarding slot, riders wait until there is an available spot in a vehicle, and board the vehicle when it is their turn. Notably, the users are not assigned to a particular vehicle. As such, each rider can decide whether to board any given vehicle, and can simply wait for other available vehicle slots. In this way, each rider has complete freedom over their ride and the occupants with which they share a ride.

Each rider in a vehicle may identify themselves to the vehicle (e.g., via a credential item), and when the vehicle is at capacity or there is no room for additional riders (e.g., due to luggage, strollers, etc.), one of the onboard users can initiate the door closure operation and begin the trip (e.g., via the vehicle user interface, device application, or the like). At any time, if a rider wishes to end a shared ride, they can initiate a termination operation (e.g., via the vehicle user interface, device application, or the like), which causes the vehicle to stop at the next available boarding zone or other egress point (or open the doors if the vehicle is still at an origin location) and allow the rider to exit.

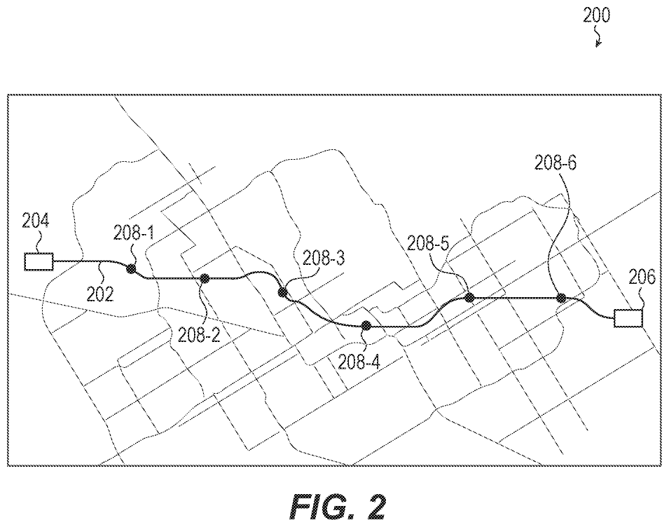

FIG. 2 illustrates a map 200 of a roadway system 202 of a transportation system (e.g., the transportation system 100). The roadway system 202 may include roadways along which vehicles may travel, and may include a first endpoint 204 and a second endpoint 206. While a single point-to-point roadway system 202 is illustrated, this is merely for simplicity, and a roadway system 202 of a transportation system may be more complex than that shown in FIG. 2. For example, a roadway system may include multiple roadways, which may intersect, diverge, and/or merge with one another to generally form the roadway system 202.

As described herein, a roadway system, such as the roadway system 202, may include a pair of roadways, each roadway configured for traffic traveling in a single direction (e.g., with each roadway configured for traffic in an opposite direction to its neighboring roadway). Thus, the pair of roadways allows vehicles to travel in both directions along a roadway system 202, with each roadway only used for vehicle traffic in a single direction. As noted, a roadway system may include more roadways, and the roadway system 202 (which may include two roadways extending between the endpoints) is merely for illustration. In some cases, any portion of a roadway system between two points (e.g., boarding zones, storage facilities, or other destinations in the transportation system) may include two (and optionally more) roadways configured for travel in opposite directions. As described herein, the roadways, or portions thereof, may be vertically separated from a grade level (e.g., elevated above grade, or located below grade).

The pair of roadways may be positioned alongside one another, and may be physically isolated from one another. For example, the opposing roadways may be separated by fences, walls, barriers, or any other suitable physical separation technique. In some cases, the opposing roadways include physically separate road surfaces (e.g., in the case of elevated roadways, each roadway may be separated by an air gap as well as barriers, walls, fences, or the like). The physical isolation may help ensure safe separation of vehicles traveling in opposite directions, and may simplify the types of vehicle operations and/or maneuvers required to safely navigate the roadway system 202.

The roadway system 202 may include boarding zones 208. The boarding zones 208 may include boarding slots that are configured to receive autonomous vehicles 108. The boarding slots may provide a parking location for the vehicles 108 where passengers can enter and exit the vehicles. Boarding zones may be configured for convenient access by passengers. For example, boarding zones may be positioned at grade level, boarding platforms may be at the same height as the vehicle floor.

The roadway system 202 may be separate from conventional vehicle traffic, and may in some cases have no intersections with roads that are accessible by conventional vehicle traffic. In some cases, this may be achieved by vertically separating portions of the roadway system 202 from conventional roads, such that conventional vehicles do not have vehicular access to the roadway system 202.

As described herein, roadways may provide thoroughfares for vehicle traffic traveling between destinations. In order to provide efficient, rapid transportation along the roadways, it may be beneficial to configure the transportation system so that travel along the roadways is not interrupted by boarding zones, intersections, cross traffic, and the like. Such efficiencies may be achieved, in part, by vertically separating roadways from other infrastructure (e.g., existing roads, sidewalks, parks, rights of way, etc.). However, as noted above, passenger access may be limited or impeded when roadways are vertically separated. Accordingly, boarding zones may be positioned at grade level. Such vertical separation between boarding zones and roadways, however, requires that infrastructure be provided to allow the elevated (or submerged) roadways to access the grade-level boarding zone. Further, due to the dense environments in which roadways and boarding zones are often deployed, as well as for cost and overall system efficiency, it may be advantageous to provide such infrastructure and functionality in a small, space-efficient footprint. Thus, described herein are arrangements for roadway systems with vertically separated roadways and boarding zones that allow convenient access to passengers as well as space-efficient access to the boarding zone from traffic in both directions and space-efficient access to the roadway segments (in both directions) from vehicles in the boarding zone.

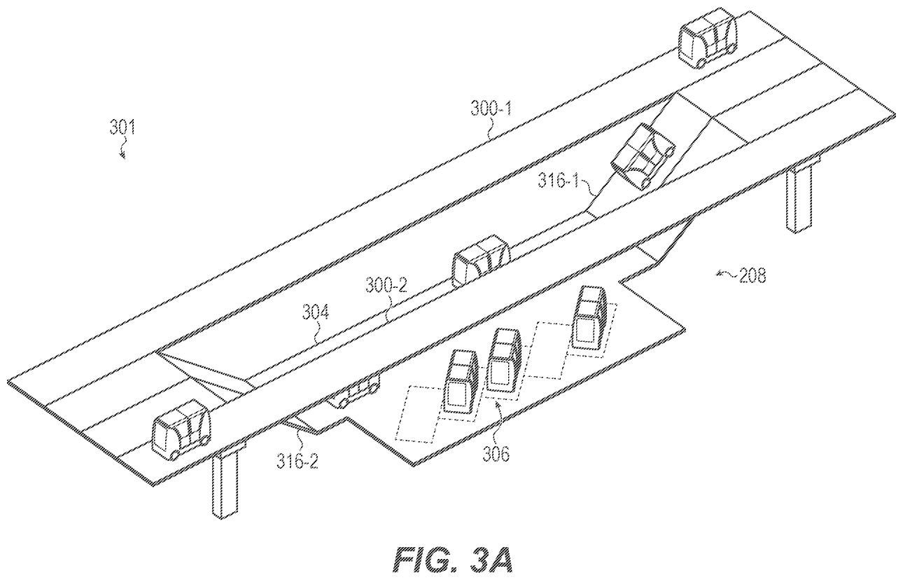

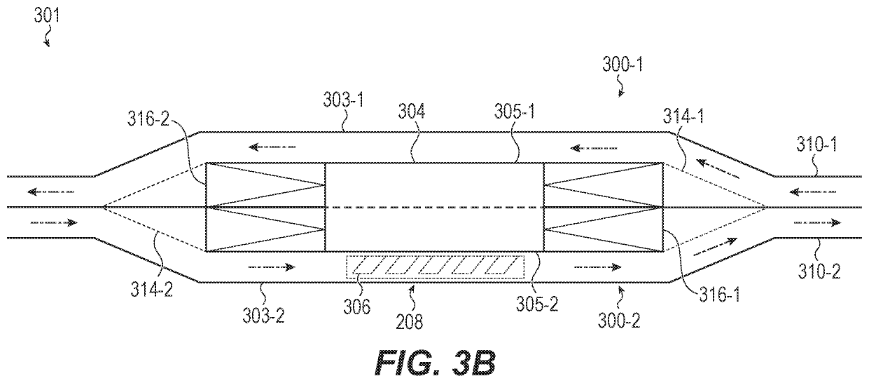

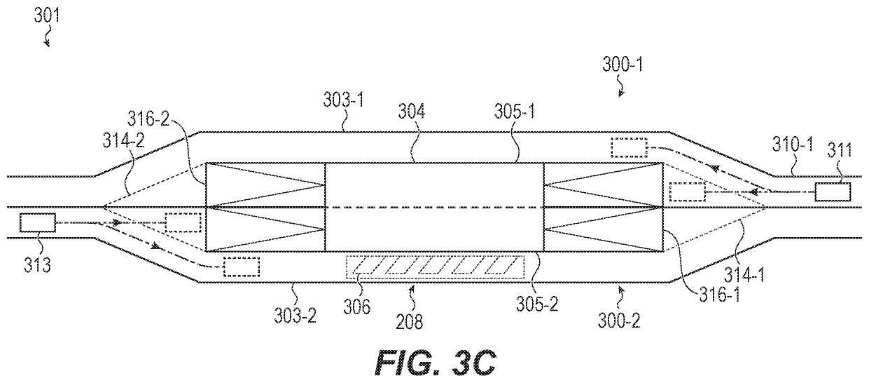

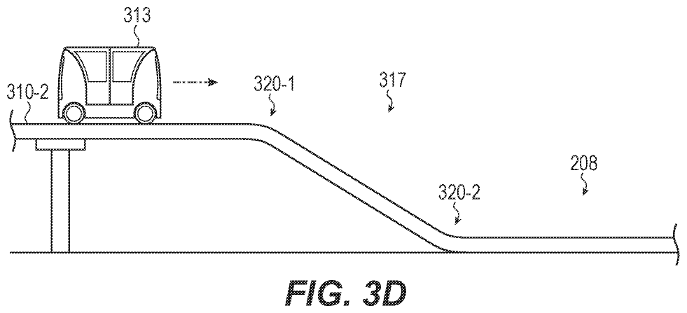

FIG. 3A illustrates an example portion of a roadway system 301 at an example boarding zone 208. As shown, the portion of the roadway system 301 includes a boarding zone 208 that is vertically separated from a pair of roadways 300. The pair of roadways 300 generally extend alongside one another and are physically divided from one another (e.g., by open space, fences, guardrails, barriers, walls, etc.). The pair of roadways 300 includes a first roadway 300-1 configured for vehicle travel in a first direction, and a second roadway 300-2 configured for vehicle travel in a second direction opposite the first direction. More particularly, the transportation system may be configured to only generate vehicle trajectories that conform to the predetermined traffic direction for each roadway. In some cases, additional levels of redundancy and safety critical functionality may be provided to ensure that vehicles do not travel against a predetermined traffic direction. For example, the vehicles themselves may include sensors (e.g., GPS, optical sensors, location sensors, etc.) that determine whether they have entered or may be about to enter a roadway against its predetermined traffic direction, and perform some operation in response to the determination (e.g., stopping, changing direction, issuing a signal to another system such as a CMS, LMS, or monitoring system, issuing a signal to another vehicle, etc.). As another example, an LMS or monitoring system may detect when a vehicle has entered or may be about to enter a roadway against its predetermined traffic direction and perform appropriate actions in response to the determination (e.g., causing one or more vehicles to stop, change direction, etc.).

The boarding zone 208 may include a set of boarding slots 306 configured to receive autonomous vehicles. The boarding slots 306 may also allow passenger access to the vehicles to facilitate boarding and exiting vehicles. The boarding zone 208 may be at grade level, as described herein, and may provide convenient grade-level access for passengers. Boarding slots 306 may be oriented at non-perpendicular angles to the mixing lanes, which may facilitate easy access to the vehicles by boarding and alighting passengers.

The boarding zone 208 may also include a vehicle mixing zone 304 adjacent to the set of boarding slots 306. The vehicle mixing zone 304 may be configured to allow vehicle access to the set of boarding slots 306 for vehicles from both the first roadway 300-1 and the second roadway 300-2. More particularly, as described herein, the mixing zone 304 may include a first mixing lane connected to the first roadway and a second mixing lane connected to the second roadway. The mixing lanes may be grade-level road segments that are configured to receive traffic traveling in a given direction, but which allow vehicles to travel in multiple directions to facilitate arrival and departure maneuvers (as defined by arrival and departure trajectories).

A mixing zone 304 is one of the limited locations within the transportation system where vehicles may travel in multiple directions, and thus different vehicle control schemes may be applied in those areas (for example, vehicle speeds may be lower in mixing zones than in continuous-travel lanes). While configurations may be implemented that maintain traffic direction restrictions (e.g., such that no multi-directional lanes or areas exist), such configurations may be less efficient for passenger access and space utilization. Accordingly, the mixing zones described herein provide a high degree of operational and geographical efficiency. Further, by limiting the areas in the transportation system where vehicles can perform multi-directional maneuvers, cross oncoming-traffic lanes, and the like, a high degree of safety can be achieved.

FIG. 3A also illustrates a particular configuration of the roadway that provides vertical separation between the roadways 300 and the boarding zone 208 while also providing highly efficient use of space and allowing traffic along the roadways to continue unimpeded by the boarding zone and the vehicles utilizing the boarding zone. In particular, the mixing zone is positioned between two elevated bypass segments (e.g., as viewed from above) and is accessed by pairs of ramps 316 that join each roadway 300 to the boarding zone 208. The ramps 316 are also positioned between the bypass segments such that the bypass segments only deviate from the path of the main thoroughfare portion of the roadways 300 by about the width of two lanes. The ramps of each pair of ramps may be positioned alongside one another, and may include physical barriers (e.g., walls, barricades, fences, etc.) to enforce physical isolation of the ramps and the vehicles thereon. Merging zones may also be included where the elevated roadways join the ramps to allow vehicles traveling along the roadways 300 to safely exit the continuous-flow areas of the roadways and decelerate prior to traversing the ramps. As shown in greater detail herein, the mixing lanes provide ample area for vehicles to maneuver in the boarding zone 208, and allow vehicles entering and exiting from either traffic direction to easily access the mixing zone 304.

FIG. 3A also illustrates the configuration of the mixing lanes 305-1, 305-2 in the mixing zone 304. The mixing lanes 305-1, 305-2 are positioned along side (e.g., parallel) to one another, with the mixing lane 305-2 positioned between the boarding slots 306 and the other mixing lane 305-1. The mixing lanes 305 may not be physically isolated or segregated. Accordingly, vehicles may be able to cross mixing lanes (e.g., the mixing lane 305-2) when entering or leaving the boarding slots 306. The connected mixing lanes 305-1, 305-2 also provide more room in which vehicles may perform arrival and departure maneuvers (e.g., relative to boarding zones with a single lane). While the mixing lanes 305 are not physically isolated from one another, the configuration of multiple parallel mixing lanes may help minimize or reduce the extent to which vehicles need to traverse lanes of traffic that are not dedicated to a single direction. For example, while both roadway segments 310 may in some cases converge to a single multi-direction lane at a boarding zone, such configurations would require vehicles to traverse the same stretch of road that is also used for oncoming traffic. By providing multiple mixing lanes along side one another, the amount of bidirectional vehicle travel in a single lane may be minimized. For example, the multiple mixing lanes allows vehicle traffic from multiple directions to access the boarding zone directly, allows room for arrival and departure maneuvers, and allows departing vehicles to access roadways in either direction, all while reducing or minimizing the amount of lane sharing, lane crossing, merging, etc.

FIG. 3B is a top-down view of the portion 301 of the roadway system. FIG. 3B illustrates example traffic directions along the roadways 300-1 and 300-2, as well as in merging zones 314-1, 314-2. As noted herein, the transportation system (e.g., a CMS of the transportation system) may enforce these traffic directions by only providing vehicle trajectories that conform to the traffic directions.

FIG. 3B also illustrates the relative positioning of various segments of the roadway system. In particular, the roadways 300-1, 300-2 may include elevated road segments 310-1, 310-2, which join elevated bypass segments 303-1, 303-2, respectively. Thus, the elevated road segments 310 jog outward (e.g., via the bypass segments 303) to provide space for the merging zones 314, ramps 316, and the mixing zone 304 (including mixing lanes 305-1, 305-2). In some cases, all of the roadway segments of the boarding zone (e.g., the ramps and mixing lanes) may be between the bypass segments 303 (as viewed from the top). This provides a highly space efficient design, while, as shown below, allowing full access to and from the boarding zone for vehicles coming from any direction. Furthermore, in some cases, the boarding slots 306 may be positioned directly under (and optionally within the outer edge of) an elevated bypass segment. Thus, in some cases, the entire boarding zone area may occupy no more than the width of four lanes, and the grade-level footprint may be even less (e.g., in the case of a boarding zone with boarding slots along only a single side of the mixing zone).

FIG. 3C illustrates the portion 301 of the roadway system, illustrating how vehicles may be routed either into a bypass segment or into a boarding zone, depending on their vehicle trajectory as defined by the CMS (or other controller of the transportation system). For example, the vehicle 311 may be traveling along a road segment 310-1 of the roadway 300-1, in a direction for which that roadway is configured within the transportation system. In one example scenario, the trajectory for the vehicle 311 causes the vehicle to continue along the bypass segment 303-1 of the roadway 300-1 by navigating around the merging zone 314-1. In this way, a vehicle that does not need to stop at the boarding zone 208 is not impeded by the boarding zone or the vehicles accessing the boarding zone. In a second example scenario in which the vehicle 311 needs to access the boarding zone 208 (e.g., to deliver and/or pickup a passenger), the trajectory for the vehicle 311 causes the vehicle to exit the roadway 300-1 at the merging zone 314-1, after which the vehicle 311 may traverse the offramp in the ramp zone 316-1 and perform the commanded arrival maneuvers to arrive in an assigned boarding slot.

Similarly, the vehicle 313 may be traveling along a road segment 310-2 of the roadway 300-2, in a direction for which that roadway is configured within the transportation system (e.g., opposite to the roadway 300-1). In one example scenario, the trajectory for the vehicle 313 causes the vehicle to continue along the bypass segment 303-2 of the roadway 300-2 by navigating around the merging zone 314-2. In this way, a vehicle that does not need to stop at the boarding zone 208 is not impeded by the boarding zone or the vehicles accessing the boarding zone. In a second example scenario in which the vehicle 313 needs to access the boarding zone 208 (e.g., to deliver and/or pickup a passenger), the trajectory for the vehicle 313 causes the vehicle to exit the roadway 300-2 at the merging zone 314-2, after which the vehicle 313 may traverse the offramp in the ramp zone 316-2 and perform the commanded arrival maneuvers to arrive in an assigned boarding slot.

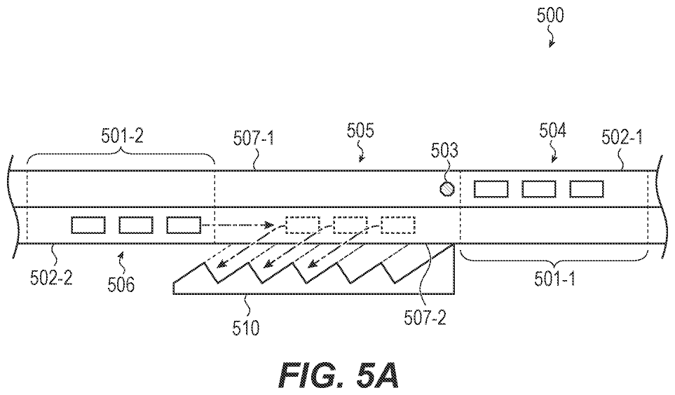

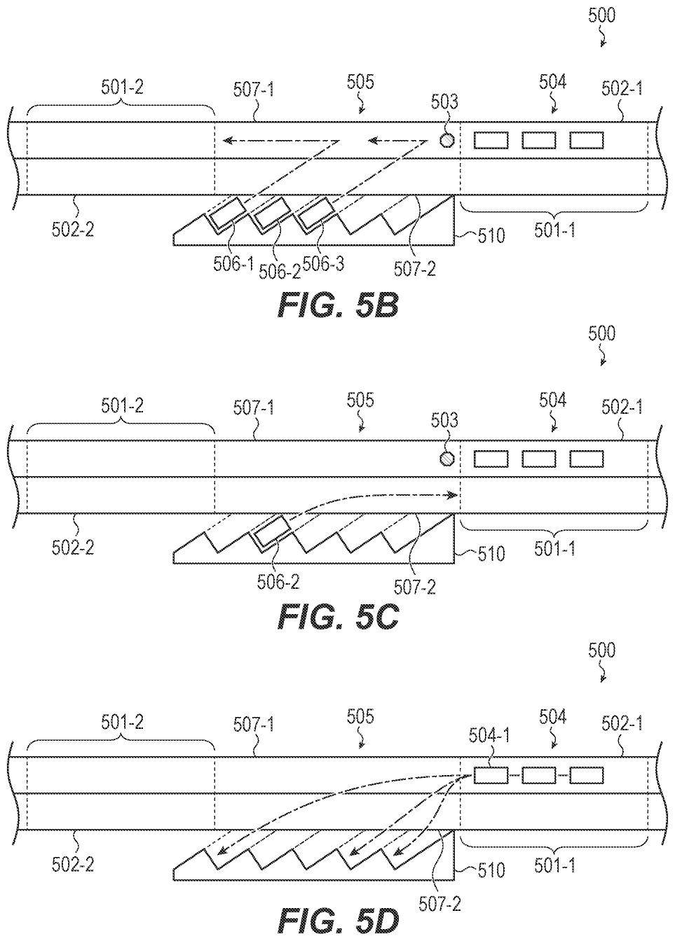

In a departure operation, vehicles may exit their assigned boarding slot, traverse the onramp corresponding to the commanded vehicle travel direction (as defined by the vehicle's assigned trajectory), and merge into the appropriate roadway. Example arrival and departure maneuvers are described herein with respect to FIGS. 5A-5D.

In some cases, the roadways and boarding zone may physically isolate vehicles traveling in different directions at all locations except the mixing zones. Thus, for example, fences, barriers, walls, air gaps, or the like, may extend along the road segments, merging zones, and ramp zones to segregate traffic in different directions.

FIG. 3D illustrates a side view of the vehicle 313 entering the boarding zone 208 from the road segment 310-2, prior to traversing the offramp 317 (which is part of the ramp zone 316-2). In some cases, the shape of the ramps (e.g., the offramp 317, which may have a same or similar geometry to other ramps in the transportation system) and the vehicle trajectories may be configured to achieve certain kinematic criteria. For example, the particular profiles of the ramp transitions 320 (e.g., the shape, contour, radius, length, etc.) as well as the ramp as a whole (e.g., the length, grade angle, etc.) may be configured such that, when a vehicle traverses the ramp 317, the vehicle stays within a set of kinematic criteria. Example kinematic criteria for a vehicle may include, without limitation, acceleration, jerk, snap, pitch, roll, and velocity.

Because a control system (e.g., the CMS 102) may determine trajectories for each vehicle in the system, the control system may ultimately control the kinematic properties of the vehicles as they traverse the roadway. Thus, in the context of the offramps and onramps at boarding zones, the vehicle trajectories for vehicles exiting and entering the boarding zones using ramps may be configured to result in the vehicle achieving the target kinematic values (e.g., staying within certain thresholds of vehicle kinematics).

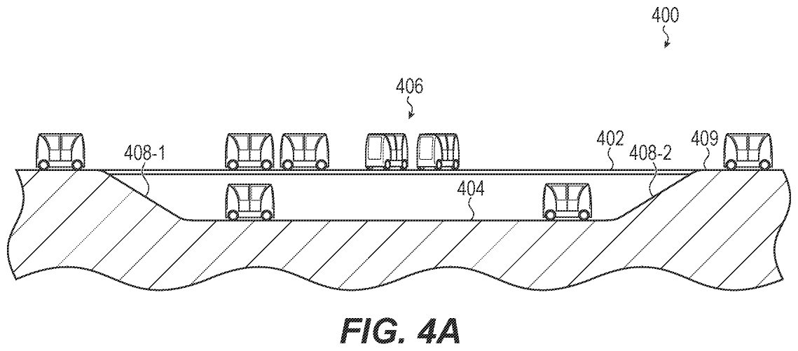

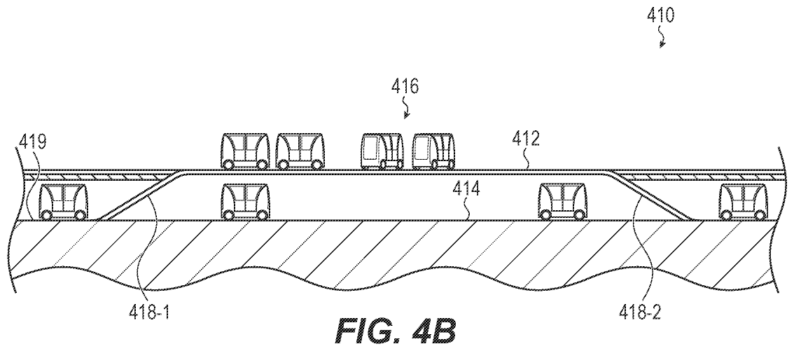

The foregoing description of the vertically separated boarding zone focuses on one example in which the roadways that access the boarding zone are elevated, the bypass segments are elevated, and the boarding zone is at grade. However, the same or similar design principles may apply to other configurations of vertical separation. For example, FIG. 4A illustrates an example portion 400 of a transportation system as described herein in which a boarding zone 406 (with mixing lanes 402) is located at grade level, the primary roadway segments 409 are located at grade level, and the bypass segments 404 are located below grade level (and accessible by ramps 408). This configuration may have generally the same arrangement as the portion 301 of the system shown in FIGS. 3A-3C, with the bypass segments extending around the boarding zone (as viewed from above), though with the bypass segments below grade instead of above grade.

FIG. 4B illustrates an example portion 410 of a transportation system as described herein in which a boarding zone 416 (with mixing lanes 412) is located at grade level, the primary roadway segments 419 are located below grade level, and the bypass segments 414 are also located below grade level. In this case, the boarding zone 416 is accessible by ramps 418. This configuration may have generally the same arrangement as the portion 301 of the system shown in FIGS. 3A-3C, with the bypass segments extending around the boarding zone (as viewed from above), though with the bypass segments below grade instead of above grade.

In all of the example boarding zones described herein, the bypass segments are shown and/or described as generally straight segments, though this need not be the case. For example, to further reduce the footprint of the roadway and boarding zone region, bypass lanes may re-converge after the merge zones (e.g., to a same or similar separation distance as at other non-boarding zone locations), further narrowing the overall footprint of the roadways. In other examples, vertically separated road segments and/or bypass segments may have non-parallel or otherwise non-conforming configurations. For example, at a given boarding zone, a bypass segment for one traffic direction may curve around a tree, building, or other structure, while the other bypass segment may extend straight.

Additionally, while the instant application illustrates boarding zone regions in which both bypass segments of the roadways are either elevated or submerged, in some cases, one bypass segment may be vertically separated from the boarding zone (e.g., submerged or elevated, to provide grade-level passenger access to the boarding zone along at least one side of the boarding zone), while the other bypass segment may be at grade. As another example, one bypass segment may be elevated, while another may be submerged. Other configurations, including configurations with multiple roadways and multiple bypass segments are also contemplated.

As described herein, vehicles may perform arrival and departure maneuvers in a boarding zone in order to arrive at and depart from the boarding slots. The maneuvers may include crossing one or more mixing lanes and changing vehicle direction one or more times, and may be defined by vehicle trajectories that are provided to the vehicles (e.g., from a control system such as the CMS 102). For example, a vehicle arriving at a boarding zone from a roadway may be provided with a vehicle arrival trajectory that is configured to cause the vehicle to enter a first mixing lane from a first roadway and cross a second mixing lane to arrive at a boarding slot. As another example, a vehicle in a boarding slot may be provided with a vehicle departure trajectory that is configured to cause the vehicle to cross the second mixing lane to initiate travel along the first roadway. As noted above, because the vehicle trajectories are fully deconflicted (e.g., they are preconfigured so as to maintain safe separation between vehicles throughout all vehicle operations and maneuvers), the vehicles can safely perform the arrival and departure maneuvers, even though they may cross mixing lanes that are otherwise accessible by vehicles traveling in different directions. In the unlikely event of a failure of the deconflicted trajectories to prevent a conflict, the vehicles may use active sensing, planning, and control to avoid an incident.

The transportation system may also be configured to coordinate arrival and departure maneuvers for multiple vehicles, such that vehicles that are performing similar maneuvers (e.g., arriving from a particular roadway, departing to a particular roadway, etc.) are synchronized. FIGS. 5A-5D depict example coordinated arrival and departure maneuvers, illustrating how such maneuvers may be performed in a boarding zone with a multi-lane mixing zone, as described herein.

FIG. 5A illustrates an example arrival operation at a boarding zone 500 for a set of vehicles 506 that are arriving from a roadway 502-2. The boarding zone 500 may be an embodiment of or otherwise represent the boarding zones described herein. In the boarding zone 500, buffer zones 501 may be provided to allow multiple vehicles to pause while arrival and/or departure operations are performed in the mixing zone 505. Buffer zones 501 may be provided at any boarding zone, and may be positioned at various locations outside of the continuous traffic lanes. Thus, for example, a buffer zone may be provided between the merging zones (where vehicles enter and exit continuous-flow road segments) and the mixing lanes of the boarding zones. The size of the buffer zones 501 (e.g., the number of vehicles that can be accommodated in a buffer zone) may vary, and may depend at least in part on the expected usage of a boarding zone, the number of boarding slots at the boarding zone, and the like.

The buffer zones 501 may be configured for unidirectional travel only, such that under normal operational conditions vehicles only travel in the buffer zones in the same direction as the roadway that they extend from. In some cases, vehicle trajectories for vehicles traveling along the roadway system may direct vehicles to terminate their trajectory at a buffer zone and await a further vehicle trajectory (e.g., from a control system such as the CMS 102) in order to define the vehicle's maneuver into a parking spot. The control system may provide the appropriate vehicle trajectories to one or more vehicles that are waiting at a buffer zone. In some cases, a single trajectory for a vehicle may provide a complete path from an origin boarding slot to a destination boarding slot, without requiring any updates or additional trajectory information to get from a buffer zone to a boarding slot.

When it is deemed safe to do so by a control system (e.g., the CMS 102, LMS 104, or the like), the one or more vehicles 506 are provided with arrival trajectories that cause the vehicle(s) to move into the mixing zone 505 and optionally perform a direction change maneuver in order to drive into an assigned boarding slot 510. As the vehicles 506 are arriving from the roadway along the same side as the boarding slots 510, the vehicles 506 do not cross any mixing lanes, as they can perform their entire arrival maneuver in the mixing lane 507-2 that is continuous with their origin roadway segment.

As noted herein, the vehicles are capable of operating bidirectionally. For example, the vehicles in a transportation system as described herein may be substantially symmetrical, such that the vehicles lack a visually or mechanically distinct front or back. Further, the wheels may be controlled sufficiently independently (for both propulsion and steering) so that the vehicle may operate in functionally identical manner no matter which end of the vehicle is facing the direction of travel. This symmetrical design may simplify arrival and departure operations, because the system can treat whichever direction of the vehicle can most easily be oriented in the direction of intended travel as the front of the vehicle.

As noted above, the transportation system may be configured to minimize the extent to which vehicles performing different maneuvers or arriving from or departing to different roadways are in a mixing zone at the same time. FIG. 5A illustrates one example in which vehicles 504 are arriving or have arrived via roadway 502-1 around the same time as vehicles 506 (or otherwise when the arrival of vehicles 504, 506 need to be coordinated to minimize interference). In this example, in order to maintain safe separation between vehicles within the mixing zone, vehicles 504 arriving at the boarding zone 500 from an opposite direction to the vehicles 506 may be instructed to pause in the buffer zone 501-1 (indicated by stop icon 503) while the vehicles 506 perform their arrival maneuver (e.g., while the vehicles 506 traverse the mixing lane 507-2 in a first travel direction, and then reverse their travel direction to enter the boarding slots). If additional vehicles arrive while the mixing zone 505 is being traversed by other vehicles, they may wait in the buffer zone along with any other vehicles already waiting.

FIG. 5B illustrates an example departure maneuver for vehicles 506 in the boarding zone 500. In this example, the vehicles 506-1 and 506-3 may be assigned to trips that include travel in the same direction along the roadway 502-1, while the vehicle 506-2 be assigned to a trip that includes travel along the roadway 502-2 (e.g., an opposing travel direction). When the vehicles 506-1 and 506-3 are ready for departure, they may be provided with departure trajectories (which may be part of their overall trip trajectories) that cause the vehicles 506-1, 506-3 to exit their boarding slot and cross the mixing lane 507-2 to initiate travel along the roadway 502-1. As shown in FIG. 5B, the vehicles 506-1, 506-3 may change direction in order to quickly orient the vehicle so that the end of the vehicle that is closest to the direction of travel is the leading (e.g., front) end of the vehicle. For example, in a first portion of the vehicle departure trajectory, the vehicle travels in a direction of a first end of the vehicle, and in a second portion of the vehicle departure trajectory, the vehicle travels in a direction of a second end of the vehicle. (It will be understood that different maneuvers and direction changes, or lack of direction changes, may be used depending on the particular configuration of the boarding slots 510, the sizes of the vehicles, the sizes of the mixing lanes, the travel direction assigned to the roadways and mixing lanes, and the like.)

As described herein, the vehicle trajectories may define complete deconflicted trips for a vehicle, such that under normal operational conditions the vehicle does not need to independently determine how to perform certain maneuvers such as departures, arrivals, and merging. For example, in some cases, the vehicle departure trajectory defines not only the maneuvers in a boarding zone, but also defines a travel path that merges the vehicle into a roadway between other vehicles having preexisting vehicle trajectories (e.g., between a first moving vehicle having a first known trajectory and a second vehicle having a second known trajectory). Because the vehicles on the roadway are following trajectories that are assigned to them by the transportation system (e.g., the CMS 102), and the trajectories define those vehicles position on the roadway with respect to time, the CMS 102 is also able to provide the departing vehicle with a fully deconflicted trajectory that safely integrates with those of the moving vehicles. Generally, the transportation system 100 is configured to generate vehicle departure trajectories based at least in part on one or more preexisting vehicle trajectories of one or more second vehicles traveling along the roadway, where the vehicle departure trajectory is configured to maintain a separation distance between the departing vehicle and the one or more second vehicles along the first roadway.

As shown in FIG. 5B, the vehicles 504 (which may be the same or different vehicles as shown in FIG. 5A) are held in the buffer zone 501-1 and outside of the mixing zone 505 while the departure maneuver is performed. In this way, safe separation of vehicles that are on different trajectories and which need to perform different maneuvers within the mixing zone 505 is maintained.

FIG. 5C illustrates an example departure maneuver for the vehicle 506-2, which may be assigned to a trip that includes travel along the roadway 502-2. In this maneuver, the vehicle 506-2 simply exits its boarding slot and begins travel along the mixing lane 507-2 and the roadway 502-2, and without any direction change or crossing a mixing lane.

FIG. 5D illustrates an example arrival maneuver for the vehicles 504, which are arriving from the roadway 502-1. In this example, once the mixing zone 505 is clear (and boarding slots are available), the vehicles 504 may be provided with arrival trajectories that cause the vehicles to enter the mixing zone 505 (e.g., in the mixing lane 507-1), cross the mixing lane 507-2 that is between the mixing lane 507-1 and the boarding slots 510, and drive into the assigned boarding slots. Thus, the vehicles 504 traverse a portion of the first mixing lane 507-1 and traverse a portion of the second mixing lane 507-2. Notably, when traversing the portion of the second mixing lane 507-1, it does so in a second travel direction opposite the travel direction of the arrival maneuver for the vehicles 506. Thus, the mixing lanes 507 are configured to allow travel in multiple, opposing or intersecting directions, but the transportation system ensures that the vehicles are able to occupy and use the mixing lanes 507 safely.

As shown in FIG. 5D, based on the direction of travel of the vehicles 504 and the orientation of the boarding slots 510, the arrival maneuver for the vehicles 504 may not include any changes in direction, though it will be understood that different maneuvers and direction changes, or lack of direction changes, may be used depending on the particular configuration of the boarding slots 510, the sizes of the vehicles, the sizes of the mixing lanes, the travel direction assigned to the roadways and mixing lanes, and the like.

In some cases, arrival and/or departure maneuvers from vehicles arriving from or departing on different roadways may be performed simultaneously while still maintaining safe separation distances between vehicles. For example, a departure operation similar to that shown in FIG. 5C may be performed substantially simultaneously or otherwise overlapping in time with part of an arrival operation similar to that shown in FIG. 5D. More particularly, the lead vehicle 504-1 of the vehicles 504 may be assigned an arrival trajectory that does not overlap or intersect with the departure trajectory of the vehicle 506-2. In such cases, the lead vehicle 504-1 may be instructed to traverse its arrival trajectory simultaneously or overlapping with the vehicle 506-2 traversing its departure trajectory (though other vehicles 504 may be instructed to wait, as their trajectories may overlap with that of the departing vehicle 506-2). Other trajectories may be performed in an overlapping or simultaneous manner based on whether arrival and departure trajectories overlap, or whether they can be performed simultaneously or overlapping while maintaining safe separation distances.

The transportation system described herein may be configured for numerous vehicles to be autonomously operated to transport passengers and/or freight along a roadway system. For example, a transportation system or service may provide a fleet of vehicles that operate within the roadway system. Vehicles in such a transportation system may be configured to operate autonomously, such as according to one or more vehicle schemes as described herein (e.g., by following fully deconflicted trajectories assigned thereto to facilitate transport and boarding operations, among other possible vehicle operations/maneuvers). As used herein, the term “autonomous” may refer to a mode or scheme in which vehicles can operate without continuous, manual control by a human operator. For example, driverless vehicles may navigate along a roadway using a system of automatic drive and steering systems that control the speed and direction of the vehicle. In some cases, the vehicles may not require steering, speed, or directional control from the passengers, and may exclude controls such as passenger-accessible accelerator and brake pedals, steering wheels, and other manual controls. In some cases, the vehicles may include manual drive controls that may be used for maintenance, emergency overrides, or the like. Such controls may be hidden, stowed, or otherwise not directly accessible by a user during normal vehicle operation. For example, they may be designed to be accessed only by trained operators, maintenance personnel, or the like.

Autonomous operation need not exclude all human or manual operation of the vehicles or of the transportation system as a whole. For example, human operators may be able to intervene in the operation of a vehicle for safety, convenience, testing, or other purposes. Such intervention may be local to the vehicle, such as when a human driver takes controls of the vehicle, or remote from the vehicle, such as when an operator sends commands to the vehicle via a remote-control system. Similarly, some aspects of the vehicles may be controlled by passengers of the vehicles. For example, a passenger in a vehicle may select a target destination, a route, a speed, control the operation of the doors and/or windows, or the like. Accordingly, it will be understood that the terms “autonomous” and “autonomous operation” do not necessarily exclude all human intervention or operation of the individual vehicles or of the overall transportation system.

The vehicles in the transportation system may include various sensors, cameras, communications systems, processors, and/or other components or systems that help facilitate autonomous operation. For example, the vehicles may include a sensor array that detects magnets or other markers embedded in the roadway and which help the vehicle determine its location, position, and/or orientation on the roadway. The vehicles may also include wireless vehicle-to-vehicle communications systems, such as optical communications systems, that allow the vehicles to inform one another of operational parameters such as their braking status, the number of vehicles ahead in a platoon, acceleration status, their next maneuver (e.g., right turn, left turn, planned stop), their number or type of payload (e.g., humans or freight), or the like. The vehicles may also include wireless communications systems to facilitate communication with a transportation system controller that has supervisory command and control authority over the transportation system.

The vehicles in the transportation system may be designed to enhance the operation and convenience of the transportation system. For example, a primary purpose of the transportation system may be to provide comfortable, convenient, rapid, and efficient personal transportation. To provide personal comfort, the vehicles may be designed for easy passenger ingress and egress, and may have comfortable seating arrangements with generous legroom and headroom. The vehicles may also have a sophisticated suspension system that provides a comfortable ride and dynamically adjustable parameters to help keep the vehicle level, positioned at a convenient height, and to ensure a comfortable ride throughout a range of variable load weights.

Conventional personal automobiles are designed for operation primarily in only one direction. This is due in part to the fact that drivers are oriented forwards, and operating in reverse for long distances is generally not safe or necessary. However, in autonomous vehicles, where humans are not directly controlling the operation of the vehicle in real-time, it may be advantageous for a vehicle to be able to operate bidirectionally. For example, the vehicles in a transportation system as described herein may be substantially symmetrical, such that the vehicles lack a visually or mechanically distinct front or back. Further, the wheels may be controlled sufficiently independently so that the vehicle may operate substantially identically no matter which end of the vehicle is facing the direction of travel. This symmetrical design provides several advantages. For example, the vehicle may be able to maneuver in smaller spaces by potentially eliminating the need to make U-turns or other maneuvers to re-orient the vehicles so that they are facing “forward” before initiating a journey.

FIGS. 6A and 6B are perspective views of an example four-wheeled roadway vehicle 600 (referred to herein simply as a “vehicle”) that may be used in a transportation system as described herein. FIGS. 6A-6B illustrate the symmetry and bidirectionality of the vehicle 600. In particular, the vehicle 600 defines a first end 602, shown in the forefront in FIG. 6A, and a second end 604, shown in the forefront in FIG. 6B. In some examples and as shown, the first and second ends 602, 604 are substantially identical. Moreover, the vehicle 600 may be configured so that it can be driven with either end facing the direction of travel. For example, when the vehicle 600 is travelling in the direction indicated by arrow 614, the first end 602 is the leading end of the vehicle 600, while when the vehicle 600 is traveling in the direction indicated by arrow 612, the second end 604 is the leading end of the vehicle 600.

The ability of the vehicles to operate bidirectionally may allow the roadway systems, and in particular boarding zones, to be made more compact. For example, when a vehicle that is configured to travel primarily only in one direction (e.g., with reverse operation being provided for convenience and maneuvering, but not for continuous driving functions) pulls into a blind parking spot, it must execute a y-turn maneuver in order to exit the parking spot and begin forward travel. On the other hand, a vehicle configured to operate equally well in either direction (e.g., a bidirectional vehicle) may can simply exit the parking spot already facing the direction of travel. Accordingly, vehicles capable of bidirectional operation require less space to maneuver in boarding zones, allowing the boarding zones to be more compact and operated more efficiently. For example, a y-turn maneuver could temporarily block more adjacent parking spots than a vehicle that can simply turn directly towards its desired direction of travel, regardless of which direction that is. And while pull-through parking spots may eliminate the need to perform y-turn maneuvers in unidirectional vehicles, boarding zones with pull-through parking spots require a larger area than those with blind parking spots. Accordingly, using bidirectional vehicles, such as the vehicle 600, facilitates the use of smaller, more compact boarding zones and for more efficient operation of the boarding zones.

The vehicle 600 may also include wheels 606 (e.g., wheels 606-1-606-4). The wheels 606 may be paired according to their proximity to an end of the vehicle. Thus, wheels 606-1, 606-3 may be positioned proximate the first end 602 of the vehicle and may be referred to as a first pair of wheels 606, and the wheels 606-2, 606-4 may be positioned proximate the second end 604 of the vehicle and may be referred to as a second pair of wheels 606. Each pair of wheels may be driven by at least one motor (e.g., an electric motor), and each pair of wheels may be able to steer the vehicle. Because each pair of wheels is capable of turning to steer the vehicle, the vehicle may have similar driving and handling characteristics regardless of the direction of travel. In some cases, the vehicle may be operated in a two-wheel steering mode, in which only one pair of wheels steers the vehicle 600 at a given time. In such cases, the particular pair of wheels that steers the vehicle 600 may change when the direction of travel changes. In other cases, the vehicle may be operated in a four-wheel steering mode, in which the wheels are operated in concert to steer the vehicle. In a four-wheel steering mode, the pairs of wheels may either turn in the same direction or in opposite directions, depending on the steering maneuver being performed and/or the speed of the vehicle.

The vehicle 600 may also include doors 608, 610 that open to allow passengers and other payloads (e.g., packages, luggage, freight) to be placed inside the vehicle 600. The doors 608, 610, which are described in greater detail herein, may extend over the top of the vehicle such that they each define two opposite side segments. For example, each door defines a side segment on a first side of the vehicle and another side segment on a second, opposite side of the vehicle. The doors also each define a roof segment that extends between the side segments and defines part of the roof (or top side) of the vehicle. In some cases, the doors 608, 610 resemble an upside-down “U” in cross-section and may be referred to as canopy doors. The side segments and the roof segment of the doors may be formed as a rigid structural unit, such that all of the components of the door (e.g., the side segments and the roof segment) move in concert with one another. In some cases, the doors 608, 610 include a unitary shell or door chassis that is formed from a monolithic structure. The unitary shell or door chassis may be formed from a composite sheet or structure including, for example, fiberglass, carbon composite, and/or other lightweight composite materials.

The vehicle 600 may also include a vehicle controller 620 (FIG. 6C) that controls the operations of the vehicle 600 and the vehicle's systems and/or subsystems. For example, the vehicle controller may control the vehicle's drive system, steering system, suspension system, doors, and the like, to facilitate vehicle operation, including to navigate the vehicle along a roadway in accordance with one or more vehicle control schemes. The vehicle controller may also be configured to communicate with other vehicles, the transportation system controller (e.g., the CMS 102), vehicle presence detectors, or other components of the transportation system (e.g., the LMS 104, TMS 106, etc.). For example, the vehicle controller may be configured to receive information from other vehicles about those vehicles' position in a platoon, speed, upcoming speed or direction changes, or the like. The vehicle controller may also be configured to receive information from vehicle presence detectors about available vehicle positions. The vehicle controller may include computers, processors, memory, circuitry, or any other suitable hardware components, and may be interconnected with other systems of the vehicle to facilitate the operations described herein, as well as other vehicle operations.

FIG. 6C is a schematic representation of the vehicle 600, illustrating an example set of systems that may facilitate and/or implement the operations and techniques described herein. The vehicle 600 may include a vehicle controller 620. The vehicle controller 620 may include a vehicle sensing subsystem 622, a vehicle communications subsystem 624, a vehicle autonomy subsystem 626, a vehicle controls subsystem 628, and a vehicle user interface subsystem 630. The vehicle controller 620 may be coupled to various physical and/or hardware components of the vehicle 600, including but not limited to propulsion system(s) 632, steering system(s) 634, braking system(s) 636, sensor(s) and/or sensing system(s) 638, door system(s) 640, user interface system(s) 642, and the like.

The vehicle sensing subsystem 622 may include or be coupled to sensing systems 638, which may include tri-band redundant sensing (lidar, radar, camera), providing high-resolution (e.g., about 0.2 to about 2.0 mrad), low-latency (e.g., less than about 100 ms latency), and long-range sensor data (e.g., greater than about 600 ft). The vehicle sensing subsystem 622 may provide and/or access sensor data that is used to determine vehicle state (e.g., position, velocity, acceleration) as well as to provide detection and localization of other objects in the system including other vehicles and any intrusions into the system.

The vehicle communications subsystem 624 may include dual-band redundant wireless communications. This subsystem may provide trajectory information (e.g., fully deconflicted vehicle trajectories) and movement authority signals to the vehicle (where the movement authority signal is a continuous signal required for any permissive state on the system). The vehicle communications subsystem 624 may also transmit vehicle state information to other system components (e.g., other vehicles, the CMS 102, an LMS 104, a TMS 106, etc.). The vehicle communications subsystem 624 may also transmit and/or receive redundant/diverse system observations (e.g., intrusion observations, vehicle observations) across the system.

The vehicle autonomy subsystem 626 may facilitate the autonomous operation of the vehicle 600 including assuring the safety of the vehicle 600 in varied conditions including any and all failures of off-vehicle components (e.g., the CMS 102, LMS 104, TMS 106, etc.). The vehicle autonomy subsystem 626 may use the output of the vehicle sensing subsystem 622 as input and, based at least in part on the output, provide vehicle ego-localization (e.g., the location of the vehicle 600 in space and/or with respect to the transportation system) and object detection/localization (including other vehicles and foreign objects on or adjacent to the guideway). The vehicle autonomy subsystem 626 may cross-check its ego-localization and object reports against diverse and redundant sources (e.g., reports from wayside MS units and other vehicles) and may enforce safety invariants with respect to these results (e.g., maintaining safe separation distances, etc.). The vehicle may periodically (e.g., at a frequency of about 10 cycles per second) or otherwise provide both a current safe motion plan and a fail-safe motion plan to the vehicle controls subsystem 628 (to be executed in the event a motion plan is not received on subsequent cycles).

The vehicle controls subsystem 628 may control vehicle actuators (e.g., propulsion, braking, steering, doors, etc.) and may maintain the vehicle in a safe state. The vehicle controls subsystem 628 may include safety-critical software running on safety-critical processing hardware (checked-redundancy via dual lockstep processors). The vehicle steering and braking systems may support a fail-safe design with respect to a loss of signal from the vehicle controls subsystem 628 via hardware watchdog timers.

The vehicle user interface subsystem 630 may facilitate user interactions within the vehicle including without limitation verifying passenger identity (via NFC scan), allowing the user to initiate the trip, and providing information to the user over the course of the trip (e.g., time to arrival, alert prior to arrival). The vehicle user interface subsystem 630 may include displays, touchscreen displays, output systems (e.g., lights, speakers) user input systems (e.g., keyboard, buttons, microphones), as well as other possible user interface components or systems.

The vehicle user interface (UI) subsystem 630 may provide various outputs and accept various inputs from passengers during a trip. For example, during a trip, the vehicle UI subsystem 630 may communicate ride progress, display messages, and provide access to customer support.

In one example, once a rider enters the vehicle, the vehicle UI subsystem 630 may provide an audio and/or visual output prompting the passenger to identify themselves (e.g., to present a credential item, ticket, etc.). The vehicle UI subsystem 630 may also include an NFC antenna, optical scanner, or other system to allow the user to identify themselves or otherwise provide credentials to the system. After the passenger identifies themself, the vehicle UI subsystem 630 may provide audio and/or visual outputs indicating that doors will close (and optionally providing a countdown, such as a 3 second countdown). At any point, the passenger can interact with the vehicle UI subsystem 630 to stop the doors from closing. Once the doors are closed, the vehicle UI subsystem 630 may provide an audio and/or visual output indicating that departure is imminent.

During the ride, a progress bar or other trip progress information (e.g., a moving indication on a map of the roadway system) may be displayed to the user, via the vehicle's user interface and/or on the user's device. During the ride, the user may access customer support via the vehicle or their mobile phone or other device. Prior to arrival at a destination, the vehicle UI subsystem 630 may produce an audio and/or visual output indicating that they are about to arrive at their destination. A countdown may optionally be provided as well.

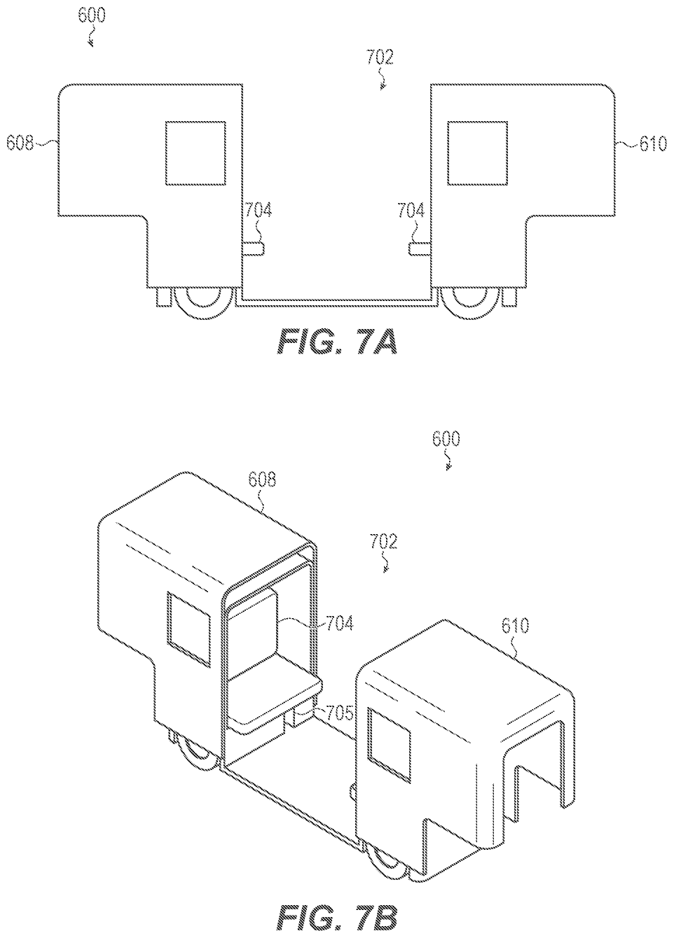

FIGS. 7A and 7B are side and perspective views of the vehicle 600 with the doors 608, 610 in an open state. Because the doors 608, 610 each define two opposite side segments and a roof segment, an uninterrupted internal space 702 may be revealed when the doors 608, 610 are opened. In the example depicted in FIGS. 7A and 7B, when the doors 608, 610 are opened, an open section may be defined between the doors 608, 610 that extends from one side of the vehicle 600 to the other. This may allow for unimpeded ingress and egress into the vehicle 600 by passengers on either side of the vehicle 600. The lack of an overhead structure when the doors 608, 610 are opened may allow passengers to walk across the vehicle 600 without a limit on the overhead clearance.

The vehicle 600 may also include seats 704, which may be positioned at opposite ends of the vehicle 600 and may be facing one another. As shown, the vehicle includes two seats 704, though other numbers of seats and other arrangements of seats are also possible (e.g., zero seats, one seat, three seats, etc.). In some cases, the seats 704 may be removed, collapsed, or stowed so that wheelchairs, strollers, bicycles, or luggage may be more easily placed in the vehicle 600. For example, the seats may be hinged or otherwise articulatable such that the seat surface can be raised to provide more room in the vehicle for other objects. In some cases, the vehicle 600 may include a bicycle retention system positioned below the seat surface, such that upon raising the seat surface, a bicycle wheel may be secured to the bicycle retention system. The bicycle retention system may include a slot 705 into which a bicycle wheel may be at least partially inserted in order to maintain the bicycle in an upright configuration. The slot 705 may be offset from a center line of the vehicle to provide adequate space for passengers and other payload.

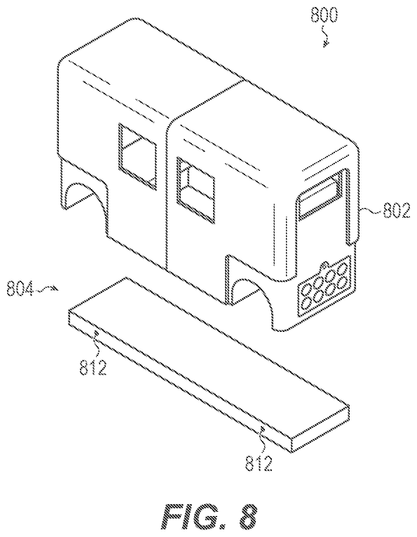

Vehicles for use in a transportation system as described herein, such as the vehicle 600, may be designed for safe and comfortable operation, as well as for ease of manufacture and maintenance. To achieve these advantages, the vehicles may be designed to have a frame structure that includes many of the structural and operational components of the vehicle (e.g., the motor, suspension, batteries, etc.) and that is positioned low to the ground. A body structure may be attached or secured to the frame structure. FIG. 8 illustrates a partial exploded view of a vehicle, which may be an embodiment of the vehicle 600, showing an example configuration of a frame structure and body structure. As described below, the low position of the frame structure combined with the relatively lightweight body structure produces a vehicle with a very low center of gravity, which increases the safety and handling of the vehicle. For example, a low center of gravity reduces the rollover risk of the vehicle when the vehicle encounters slanted road surfaces, wind loading, sharp turns, or the like, and also reduces body roll of the vehicle during turning or other maneuvers. Further, by positioning many of the operational components of the vehicle, such as motors, batteries, a vehicle controller, sensors (e.g., sensors that detect road-mounted magnets or other markers), and the like, on the frame structure (e.g., the frame structure 804, FIG. 8), manufacture and repair may be simplified.

FIG. 8 is a partial exploded view of a vehicle 800, which may be an embodiment of the vehicle 600. Details of the vehicle 600 may be equally applicable to the vehicle 800, and will not be repeated here. The vehicle 800 may include a body structure 802, which may include doors (e.g., the doors 608, 610, described above) and other body components, and a frame structure 804 to which the body structure 802 is attached.

The frame structure 804 may include drive, suspension, and steering components of the vehicle. For example, the frame structure 804 may include wheel suspension systems (which may define or include wheel mounts, axles, or hubs, represented in FIG. 8 as points 812), steering systems, drive motors, and optionally motor controllers. Wheels may be mounted to the wheel suspension systems via the wheel mounts, axles, hubs, or the like. The drive motors may include one or more drive motors that drive the wheels, either independently or in concert with one another. The drive motors may receive power from a power source (e.g., battery) that is mounted on the frame structure 804. Motor controllers for the drive motors may also be mounted on the frame structure 804.

The suspension systems may be any suitable type of suspension system. In some cases, the suspension systems include independent suspension systems for each wheel. For example, the suspension systems may be double-wishbone torsion-bar suspension systems. The suspension systems may also be dynamically adjustable, such as to control the ride height, suspension preload, damping, or other suspension parameters while the vehicle is stationary or while it is moving. Other suspension systems are also contemplated, such as swing axle suspension, sliding pillar suspension, MacPherson strut suspension, or the like. Moreover, spring and damping functions may be provided by any suitable component or system, such as coil springs, leaf springs, pneumatic springs, hydropneumatic springs, magneto-rheological shock absorbers, and the like. The suspension systems may be configured to operate in conjunction with the contour of a road surface (e.g., of a roadway as described above) to maintain a desired experience for a passenger.

The frame structure 804 may also include steering systems that allow the wheels to be turned to steer the vehicle. In some cases, the wheels may be independently steerable, or they may be linked (e.g., via a steering rack) so that they always point in substantially the same direction during normal operation of the vehicle. Further, this allows the vehicles to use four-wheel steering schemes, as well as to alternate between two-wheel steering and four-wheel steering schemes.

The frame structure 804 may include components such as batteries, motors, and mechanisms for opening and closing the vehicle's doors, control systems (including computers or other processing units), and the like.

FIG. 8 illustrates example configurations of vehicles and frame structures. Other configurations are also possible, however. Moreover, the frame structure and the body structure shown in FIG. 8 are intended more as schematic representations of these components, and these components may include other structures that are omitted from FIG. 8 for clarity. Additional structural connections and integrations may be made between the body structure and the frame structure than are explicitly represented in FIG. 8. For example, components of a door mechanism that open and close the doors of the body structures may be joined to both the doors and to the frame structure.

FIG. 9 illustrates a sample electrical block diagram of an electronic device 900 that may perform the operations described herein. The electronic device 900 may in some cases take the form of any of the electronic devices described herein, including the CMS 102, LMS 104, TMS 106, vehicle controller 620, vehicle user interface, boarding zone kiosks, portable electronic devices, or other computing devices or systems that are described herein or that are usable in order to perform the operations or instantiate the systems and/or services described herein. The electronic device 900 can include one or more of a display 912, a processing unit 902, a power source 914, a memory 904 or storage device, input devices 906, and output devices 910. In some cases, various implementations of the electronic device 900 may lack some or all of these components and/or include additional or alternative components.

The processing unit 902 can control some or all of the operations of the electronic device 900. The processing unit 902 can communicate, either directly or indirectly, with some or all of the components of the electronic device 900. For example, a system bus or other communication mechanism 916 can provide communication between the processing unit 902, the power source 914, the memory 904, the input device(s) 906, and the output device(s) 910.

The processing unit 902 can be implemented as any electronic device capable of processing, receiving, or transmitting data or instructions. For example, the processing unit 902 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 900 can be controlled by multiple processing units. For example, select components of the electronic device 900 (e.g., an input device 906) may be controlled by a first processing unit and other components of the electronic device 900 (e.g., the display 912) may be controlled by a second processing unit, where the first and second processing units may or may not be in communication with each other.

The power source 914 can be implemented with any device capable of providing energy to the electronic device 900. For example, the power source 914 may be one or more batteries or rechargeable batteries. Additionally or alternatively, the power source 914 can be a power connector or power cord that connects the electronic device 900 to another power source, such as a wall outlet.

The memory 904 can store electronic data that can be used by the electronic device 900. For example, the memory 904 can store electronic data or content such as, for example, trip requests, user information, historical usage data, maps and/or layouts of the transportation system, vehicle data (e.g., information about each vehicle in the system, including assignment status, remaining charge, maintenance history, etc.), or the like. The memory 904 can be configured as any type of memory. By way of example only, the memory 904 can be implemented as random access memory, read-only memory, Flash memory, removable memory, other types of storage elements, or combinations of such devices.

In various embodiments, the display 912 provides a graphical output, for example associated with an operating system, user interface, and/or applications of the electronic device 900. In one embodiment, the display 912 includes one or more sensors and is configured as a touch-sensitive (e.g., single-touch, multi-touch) and/or force-sensitive display to receive inputs from a user. For example, the display 912 may be integrated with a touch sensor (e.g., a capacitive touch sensor) and/or a force sensor to provide a touch- and/or force-sensitive display. The display 912 is operably coupled to the processing unit 902 of the electronic device 900.

The display 912 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 912 is positioned beneath and viewable through a cover that forms at least a portion of an enclosure of the electronic device 900.

In various embodiments, the input devices 906 may include any suitable components for detecting inputs. Examples of input devices 906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 906 may be configured to detect one or more particular types of input and provide a signal (e.g., an input signal) corresponding to the detected input. The signal may be provided, for example, to the processing unit 902.

The output devices 910 may include any suitable components for providing outputs. Examples of output devices 910 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 910 may be configured to receive one or more signals (e.g., an output signal provided by the processing unit 902) and provide an output corresponding to the signal.

In some cases, input devices 906 and output devices 910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 902 may be operably coupled to the input devices 906 and the output devices 910. The processing unit 902 may be adapted to exchange signals with the input devices 906 and the output devices 910. For example, the processing unit 902 may receive an input signal from an input device 906 that corresponds to an input detected by the input device 906. The processing unit 902 may interpret the received input signal to determine whether to provide and/or change one or more outputs in response to the input signal. The processing unit 902 may then send an output signal to one or more of the output devices 910, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. For example, while the methods or processes disclosed herein have been described and shown with reference to particular operations performed in a particular order, these operations may be combined, sub-divided, or re-ordered to form equivalent methods or processes without departing from the teachings of the present disclosure. Moreover, structures, features, components, materials, steps, processes, or the like, that are described herein with respect to one embodiment may be omitted from that embodiment or incorporated into other embodiments. Further, while the term “roadway” is used herein to refer to structures that support moving vehicles, the roadways described herein do not necessarily conform to any definition, standard, or requirement that may be associated with the term “roadway,” such as may be used in laws, regulations, transportation codes, or the like. As such, the roadways described herein are not necessarily required to (and indeed may not) provide the same features and/or structures of a “roadway” as defined or used in other contexts. Of course, the roadways described herein may comply with any and all applicable laws, safety regulations, or other rules for the safety of passengers, bystanders, operators, builders, maintenance personnel, or the like.

What is claimed is:

1. A transportation system for autonomous vehicles, comprising:
a control system configured to determine respective vehicle trajectories for respective autonomous vehicles and to provide the respective vehicle trajectories to the respective autonomous vehicles;
a pair of roadways extending alongside one another and physically divided from one another, a first roadway of the pair of roadways configured for vehicle travel in a first direction, and a second roadway of the pair of roadways configured for vehicle travel in a second direction opposite the first direction;
a boarding zone that is vertically separated from the pair of roadways and comprises:
a set of boarding slots configured to receive autonomous vehicles; and
a mixing zone adjacent the set of boarding slots and configured to allow vehicle access to the set of boarding slots for vehicles from the first roadway and the second roadway, the mixing zone comprising:
a first mixing lane connected to the first roadway; and
a second mixing lane connected to the second roadway and positioned between the first mixing lane and the set of boarding slots, wherein:
the control system is configured to:
provide a vehicle arrival trajectory to a vehicle, the vehicle arrival trajectory configured to cause the vehicle to enter the first mixing lane from the first roadway and cross the second mixing lane to arrive at a boarding slot; and
provide a vehicle departure trajectory to the vehicle in the boarding slot, the vehicle departure trajectory configured to cause the vehicle to cross the second mixing lane to initiate travel along the first roadway.

2. The transportation system of claim 1, wherein:
in a first portion of the vehicle departure trajectory, the vehicle travels in a direction of a first end of the vehicle; and
in a second portion of the vehicle departure trajectory, the vehicle travels in a direction of a second end of the vehicle.

3. The transportation system of claim 1, wherein the pair of roadways are vertically elevated relative to the boarding zone.

4. The transportation system of claim 1, wherein:
the boarding zone is at grade level; and
the pair of roadways are below grade level.

5. The transportation system of claim 1, wherein the vehicle departure trajectory defines a travel path that merges the vehicle into the first roadway between a first moving vehicle having a first known trajectory and a second vehicle having a second known trajectory.

6. The transportation system of claim 1, wherein:
the vehicle is a first vehicle; and
the control system is configured to generate the vehicle departure trajectory based at least in part on a preexisting vehicle trajectory of a second vehicle traveling along the first roadway, the vehicle departure trajectory configured to maintain a separation distance between the first vehicle and the second vehicle along the first roadway.

7. The transportation system of claim 1, wherein the first mixing lane and the second mixing lane are positioned between a bypass segment of the first roadway and a bypass segment of the second roadway.

8. A method of operating vehicles in a transportation system comprising a plurality of autonomous vehicles configured to autonomously navigate along a roadway system, comprising:
at a control system configured to determine respective vehicle trajectories for respective autonomous vehicles and to provide the respective vehicle trajectories to the respective autonomous vehicles:
providing a first vehicle trajectory to a first vehicle, the first vehicle trajectory including instructions to autonomously travel along a first roadway to a first buffer zone connected to a first mixing lane of a boarding zone;
providing a second vehicle trajectory to a second vehicle, the second vehicle trajectory including instructions to autonomously travel along a second roadway to a second buffer zone connected to a second mixing lane of the boarding zone;
initiating a first arrival operation including:
causing the first vehicle to pause in the first buffer zone; and
causing the second vehicle to traverse a portion of the second mixing lane in a first travel direction and enter a first boarding slot; and
after the first arrival operation, initiating a second arrival operation including causing the first vehicle to traverse a portion of the first mixing lane and traverse the portion of the second mixing lane in a second travel direction opposite the first travel direction and enter a second boarding slot.

9. The method of claim 8, wherein the respective vehicle trajectories for the respective autonomous vehicles include a minimum separation distance between the respective autonomous vehicles.

10. The method of claim 8, further comprising, after the second arrival operation, initiating a coordinated vehicle departure operation including:
providing a third vehicle trajectory to the first vehicle, the third vehicle trajectory configured to cause the first vehicle to exit the second boarding slot and autonomously travel along the second roadway; and
providing a fourth vehicle trajectory to the second vehicle, the fourth vehicle trajectory configured to cause the second vehicle to exit the first boarding slot at a same time that the first vehicle exits the second boarding slot and autonomously travel along the second roadway.

11. The method of claim 8, wherein the boarding zone is vertically separated from the first roadway and the second roadway.

12. The method of claim 11, wherein the boarding zone is between a first bypass segment of the first roadway and a second bypass segment of the second roadway.

13. The method of claim 11, wherein:
the first roadway is a first elevated roadway;
the second roadway is a second elevated roadway;
a first ramp connects the first elevated roadway to the first mixing lane; and
a second ramp connects the second elevated roadway to the second mixing lane.

14. A roadway system for autonomous vehicles, comprising:
a grade-level boarding zone comprising:
a first grade-level road segment configured to receive traffic traveling in a first direction;
a second grade-level road segment configured to receive traffic traveling in a second direction opposite the first direction; and
a set of boarding slots along a side of the first grade-level road segment and accessible via the first grade-level road segment and the second grade-level road segment;
a first roadway configured for traffic traveling in the first direction and comprising:
a first elevated road segment;
a second elevated road segment;
a first offramp joining the first elevated road segment of the grade-level boarding zone to the first grade-level road segment;
a first onramp joining the first grade-level road segment of the grade-level boarding zone to the second elevated road segment; and
a first elevated bypass segment joining the first elevated road segment to the second elevated road segment; and
a second roadway configured for traffic traveling in the second direction and comprising:
a third elevated road segment;
a fourth elevated road segment;
a second offramp joining the third elevated road segment to the second grade-level road segment of the grade-level boarding zone;
a second onramp joining the second grade-level road segment of the grade-level boarding zone to the fourth elevated road segment; and
a second elevated bypass segment joining the third elevated road segment to the fourth elevated road segment.

15. The roadway system of claim 14, wherein the first and second onramps and the first and second offramps are between the first elevated bypass segment and the second elevated bypass segment.

16. The roadway system of claim 14, wherein the boarding zone lacks intersections with roads accessible by conventional vehicle traffic.

17. The roadway system of claim 14, wherein the first roadway is physically isolated from the second roadway.

18. The roadway system of claim 14, wherein:
the first onramp is alongside the second offramp; and
the second onramp is alongside the first offramp.

19. The roadway system of claim 14, further comprising a control system configured to determine respective vehicle trajectories for respective autonomous vehicles and to provide the respective vehicle trajectories to the respective autonomous vehicles, the respective vehicle trajectories for the respective autonomous vehicles configured to maintain a minimum separation distance between the respective autonomous vehicles.

20. The roadway system of claim 19, wherein the control system is further configured to:
provide a vehicle arrival trajectory to a vehicle, the vehicle arrival trajectory configured to cause the vehicle to enter the first grade-level road segment from the first roadway and cross the second grade-level road segment to arrive at a boarding slot; and
provide a vehicle departure trajectory to the vehicle in the boarding slot, the vehicle departure trajectory configured to cause the vehicle to cross the second grade-level road segment to initiate travel along the first roadway.
